(19) United States
(12) Patent Application Publication
(10) Pub. No.: US 2006/0075507 A1
(43) Pub. Date: Apr. 6, 2006

(54) Secure protocols for use with microsoft directshow filters

(75) Inventor: Randy Langer, Port Orchard, WA (US)

Correspondence Address: FITCH EVEN TABIN AND FLANNERY, 120 SOUTH LA SALLE STREET, SUITE 1600, CHICAGO, IL, 60603-3406, US

(73) Assignee: Sonic Solutions, Novato, CA (US)

(21) Appl. No.: 11/240,843

(22) Filed: Sep. 30, 2005

Related U.S. Application Data
(63) Continuation of application No. 10/237,393, filed on Sep. 6, 2002.
(60) Provisional application No. 60/317,754, filed on Sep. 6, 2001.

(51) Int. Cl. H04N 7/16; H04L 9/32; G06F 17/30; G06F 7/04; G06K 9/00; H03M 1/68; H04K 1/00; H04L 9/00

(52) U.S. Cl. 726/26

(57) ABSTRACT

Some embodiments provide methods and systems for use in processing encrypted media content through a media processing stack, wherein the media processing stack comprises one or more ordered and successively arranged processing components. These embodiments receive the media content at each successive processing component and pass the media content to a successive processing component; optionally process the media content at each processing component; receive one or more decryption keys associated with the media content at one of the processing components; relay the decryption keys to one or more successive processing components to a decrypting one of the processing components that is capable of decrypting the media content, and decrypt the media content at the decrypting one of the processing components before passing the media content to the successive processing component.

This application is a continuation of U.S. patent application Ser. No. 10/237,393, filed Sep. 6, 2002, entitled “SECURE PROTOCOLS FOR USE WITH MICROSOFT DirectShow FILTERS” that claims the benefit under 35 U.S.C. §119(e) to U.S. Provisional Application No. 60/317,754 filed Sep. 6, 2001, both of which are incorporated herein by reference in their entirety.

### BACKGROUND OF THE INVENTION

1. Technical Field

The goal of this invention is to define an enhancement to the design of software components called filters that operate in the Microsoft DirectShow environment.

The DirectShow architecture is very much an “open architecture” in that a skilled programmer can readily create a filter of his/her own that will seamlessly integrate into a DirectShow application (called a graph). Little limitation is placed on what a given filter can do internally; the DirectShow specification places more emphasis on how filters connect and interact at the connection level rather than establish much in the way of rules, policies, constraints, etc. as to what a filter does internally once it has received data from a connection point.

For the most part, this is a positive aspect of DirectShow, but it does pose a problem when the issue of “valuable” data being processed though a DirectShow graph is considered. The concept of “valuable” data is meant to imply whatever the content owner wants it to imply; a content provider would probably not consider the evening news program to be valuable data, whereas the HDTV broadcast of Titanic would be quite valuable in the bootleg market. Premium feeds such as Showtime and HBO might deem the majority of their content as valuable.

The problem such content providers face when addressing the capabilities of an open-architecture processing mechanism such as DirectShow is that there is little stopping a prospective pirate from designing and deploying a filter to capture this “valuable” data to a disk file for subsequent unauthorized distribution (“bootlegging”). The freedoms provided by open architectures such as DirectShow typically carry this danger along as an apparently unavoidable consequence.

The purpose of this invention is to define a protocol governing inter-filter connections such that they can be used in the normal (“insecure”) mode when “non-valuable” data is to be processed, but to exclude filters that do not possess appropriate “certification” from being useful when “valuable” data is to be handled. The content providers maintain control over this filter “certification” mechanism, disabling pirate filters from capturing or otherwise gaining access to valuable data, thus enforcing the copyright protection of said content.

2. Description of the Prior Art

This invention is designed as an enhancement concept to existing architectures, initially Microsoft DirectShow. All theses architectures are in effect “prior art,” except they have not demonstrated any generally acceptable solution to the piracy problem as addressed by the current invention. It is the intent of the current invention to not disable any such architecture from supporting existing designs;. that is, this is intended to be a fully backwards-compatible enhancement to existing facilities.

### SUMMARY OF THE INVENTION

The current invention operates by encrypting the data stream flowing across an inter-filter connection if the data in question is considered “valuable” (an attribute defined by the security or lack thereof when the data stream entered a filter; as a rule, if the incoming data was secure [encrypted], then the corresponding output data will also be secured).

A given filter can be either a “traditional” filter (one that does not understand or support the capabilities of the current invention) or a “secure” filter (one that does support the capabilities of the current invention, as well as the capabilities of “traditional” filters). If the sourcing side of a connection is a secure filter, and it views the data going out a connection as “valuable”, it will secure (encrypt) the data whether or not the sinking side of the connection is a secure filter (if the sinking side is not a secure filter, it can do nothing with the secured data it receives, nor will any of the filters that follow this non-secure sink filter be able to do anything with the secured data). If the sourcing side sees the outgoing data as “non-valuable”, it will not secure that data, so any otherwise conforming filter can usefully function as the sink side of the connection.

The source side of a connection, if it is a filter enhanced to support the current invention, uses a protocol with the sink side of a connection to it to allow for useful processing of secured (encrypted) data. The basic mechanism of control is whether or not the source side sends the decryption key(s) to the sink side; if it does not, the sink side (and any filters that follow it) will not be able to do anything useful with the secured data coming from the source filter in this example. The source decides on whether to send these decryption keys based on authenticating a “certificate” for the sink side filter. This certificate can be implemented in numerous forms, but in the preferred embodiment this is some type of digital signature of the sink side filter that can be validated at run time (preferably by validating the executing image of the sink side filter, rather than that filter's disk file), which is further strengthened by being able to determine with a high level of confidence that the signature was generated by a trusted entity (otherwise, the prospective pirate could simply forge his own digital signature). Only if these tests succeed does the source side send the sink side the decryption key(s).

A secure filter is inherently a dual-mode filter, in that it can support “traditional” streams as readily as the new “secure” streams. A “traditional” filter can in theory accept either type of stream, but cannot do anything useful with a “secure” stream.

Additional aspects, features and advantages of the present invention are included in the following description of exemplary embodiments, which description should be read in conjunction with the accompanying drawings.

### BRIEF DESCRIPTION OF THE DRAWINGS

FIG. 1 shows media sample architecture for a traditional media sample and a secure media sample.

FIG. 2 is flow control according to an exemplary embodiment.

### DESCRIPTION OF EXEMPLARY EMBODIMENTS OF THE INVENTION

The current invention is an inter-filter connection enhancement that allows for the movement of “valuable” data between filters only if the filters in question have an acceptable “certificate” indicating that they will not compromise the intent of the copyright protection that might be enjoyed by the data being so moved. From a practical standpoint, this gating of data access is typically accomplished via encryption rather than the simple non-action of not sending any data across the connection at all. Security is implemented by selectively sending the decryption key(s) to the sink (receiving) side of the connection if the source (transmitting) side has verified the credential of the sinking filter to its (the source filter's) satisfaction. Data not deemed “valuable” is simply not encrypted, and can thus be processed by any otherwise conforming filter, secure or “traditional”.

Some terminology will aid in the discussion here:
A filter is a software entity (component) which processes data. Such a filter must have connection points in order to do something useful. A connection point is called a pin. Pins may have numerous attributes, but from the standpoint of this invention, the primary attribute is whether the pin is an output (source) pin or an input (sink) pin. A given filter may have source pins, sink pins, or both.
When two pins are associated such that data can move across them, they are said to be connected, and the result is called a connection. Two filters might have multiple pin connections between them, but from the standpoint of this invention, they are each considered to be separate, individual, independent connections.
Data moves across a pin connection via a construct called a mediasample. The amount of content data in a given mediasample is usually not a fixed parameter; it can vary from one sample to another even within the same pin connection. Typically, there is some upper limit as to how much content data can be represented by a single mediasample, but this has no practical impact on the current invention. So far as the current invention is concerned, mediasamples carrying no content data at all are permissible (although the “enclosing” filter might object to this).
The current invention makes a distinction between secure mediasamples and “insecure” (traditional) mediasamples. Secure mediasamples are an additive enhancement to insecure samples; a secure mediasample has all the characteristics of a corresponding insecure sample instance. Put another way, a secure mediasample is an extension of an insecure mediasample. Any context that an insecure mediasample might be used, a secure mediasample is also valid (except for the constraints introduced by the encryption of the content data).

When the source side of a connection is about to propagate out a mediasample to a connected sink filter, it first makes a determination if the content data of that mediasample is deemed secure. The basis for this determination is under the control of the system's designer, but in the preferred embodiment one contributing issue to the decision on whether to make an outgoing mediasample secure is the security characteristics of the incoming mediasample(s) used to generate the outgoing mediasample; if any of these incoming mediasamples were secure (encrypted, for example), then this outgoing mediasample is likewise made secure (e.g., encrypted). Other factors can be used to influence this decision; this is completely up to the system's designer(s).

Any given mediasample propagating out of an enhanced filter will fall into one of three categories based on the data being conveyed:
Insecure content
Secure (probably encrypted) content
Decryption keys

An extension to the mediasample data structure is required to usefully convey all but the first category (which corresponds to insecure, “traditional” mediasamples). This extension consists of a set of data items. This extension data item(s) have either a default value(s) or specific bit(s) to indicate that the mediasample in question can be view as a “traditional” (i.e., insecure) mediasample.

Sink filters that do not support the enhancements defined by this invention will typically be unaware of the extension data, and will view all incoming mediasamples as being traditional (insecure) samples. If they are in fact secure samples, the actions taken by the sink filter to this encrypted data are dependent on how that filter handles “garbage” data; but that is outside the scope of this invention. If a non-secure filter is connected as the sink to a secure filter, the results are simply undefined by the concepts set forth by the current invention if the source side filter sends out secure mediasamples (if the source filter sends out insecure mediasamples, any otherwise appropriate sink filter, enhanced or not, should be able to correctly process those mediasamples). A secure filter can use both secure and insecure mediasamples as input.

Every secure filter that can act as a sink to another secure filter is required to have available at runtime a “certificate” attesting to that candidate sink filter's authenticity by some agreed-to entity that it (the candidate sink filter) will not undertake any actions that could serve to undermine the security of data flowing into it. The source side of the connection will attempt to validate this certificate for the sink filter in the connection before sending any mediasamples containing decryption keys (it might send encrypted mediasamples to the sink prior to sending a decryption key, but of course the sink side of the connection will not be able to do anything useful with these mediasamples).

There are conceptually two components to a “certificate” for a secure filter implementing the precepts set forth by the current invention:
A digital signature of the filter that can be validated by the executing image of that filter (in contrast to, for example, the disk file of that filter), and
A mechanism that ensures that the certificate was provided by a trusted entity, and not (for example) simply created by a prospective pirate in order to get his/her “rogue” filter accepted into a secure application (graph).

While the design of these kinds of certificates has been the subject of years of research and design, and the basis for countless implementations by a large, diverse set of individuals and companies, most efforts do not provide the specific characteristics considered desirable by the current invention, Accordingly, the current invention defines a standard by which any candidate certificate mechanism can be compare to. This standard is comprised as follows:
The certificate must be validated (although not necessarily created) by the executing image of the filter, rather than by (for example) its disk file. Thus, when a source filter is validating the certificate of a sink filter it (the source filter) is connected to, it must validate the executing image of the sink filter against the certificate.
The certificate must be able to detect, with a high level of confidence, if the corresponding filter has been altered in a manner that could serve to undermine the security of data flowing into it. This does not mandate that every single byte of the filter's executing image be included in the creation and/or validation of the certificate, only that any alteration of the filter that could serve to undermine the security of data flowing into it will be detected with a high level of confidence. If a filter is broken into pieces that could be individually modified (e.g., a main filter executable and one or more dependent dynamic link libraries), the entire effective “composite filter” must be adequately covered by the certificate (or each “piece” not covered by the “composite filter certificate” must have its own certificate).
Preferably, the certificate will be embedded into the executing image of the filter it is certifying. It is understood that this will not be feasible in all situations, so the current invention allows for certificates to be stored in separate data files, so long as it can be assumed with a high level of confidence that a certificate will match the filter (or other executing image) it was created for and no other.
Every certificate must be issued or unambiguously validated by a “signing authority” acceptable to all parties involved (the manufacturer of the filters, the copyright owners of the content, etc.). The ability to determine this validity for a given certificate must be available to any process that wishes to authenticate a certificate; unless a certificate can be so validated, it must be considered to be unreliable. Therefore, any use of the certificate to authenticate a filter (or other executing image) would be disqualified. What ever mechanism is used to ensure the validity of a certificate should be itself immune from undetectable alteration.

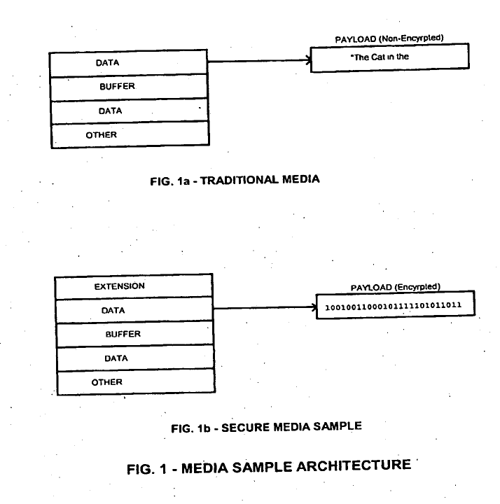

FIG. 1 shows a “traditional” media sample and an enhanced media sample that supports encryption. In either case, a media sample is a structure that contains, among other things, a pointer to a buffer that contains the “payload” data. In a traditional media sample, this payload is “in the clear,” i.e., not encrypted (at least, from .the viewpoint of this invention). Since this is a traditional media sample, :there is no need for the extension data in the media sample structure (this extension data could be in the sample, but it is set to value(s) that indicate that the media sample in question is not to be viewed as different from a traditional media sample).

In a secure media sample, the payload is encrypted, and the media sample structure containing the pointer to the encrypted payload also includes the extension data to indicate that this is a secure sample.

Because it is generally the most convenient mechanism, the decryption keys are typically interleaved with the encrypted media samples to force the synchronization between the samples and the keys. In this case, the decryption key(s) are sent as specialized media samples with data in the extension data indicating this special usage. Of course, the source side of the connection only sends these decryption key “media samples” if the sink side passed the authentication test. The source side can send the encrypted media samples regardless, since the sink side can do nothing useful with them unless it also received the decryption key(s).

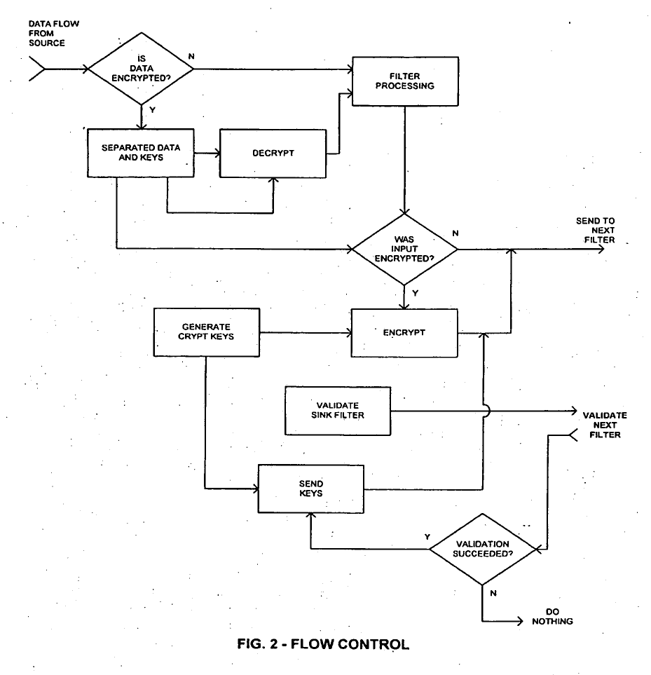

FIG. 2 shows how a filter's I/O might be architected. At the input side, the extension data (if present) is queried to see if the incoming media sample is encrypted (or is a decryption key); if so, it is pre-processed appropriately before being dispatched to the filter's normal internal processing. Received decryption keys are simply consumed at this point in the processing, and aren't forwarded on to the rest of the filter. After the filter does whatever it's going to do with the incoming data, it looks to see if any of the data contributing to this output media sample was secure (e.g.,—encrypted); if so, it is likewise encrypted with the key for this outgoing connection (each connection devises and uses its own independent key data).

To increase the level of security, the keys used by a connection are typically changed frequently. Each time a new key set is created, the source side of the connection checks as to whether the sink side passed authentication; if so, it transmits the decryption key down to the sink side. Since it presents the fewest problems for synchronization, these decryption keys are usually sent interleaved with the (encrypted) content data.

As noted in the Background, open-architecture design frameworks such as Microsoft DirectShow and the need to protect copyrighted content data from piracy represents an ongoing conflict of reasonable goals. The current invention attempts to address this conflict in such a manner that both are served and neither is dealt with inadequately. To be both truly useful and likely to be accepted by the general development community, any solution to this conflict must be backwards-compatible to the existing frameworks prior to the introduction of the invention. This argues for a “purely additive” enhancement to existing facilities, and the exclusion of something completely new and incompatible.

The current invention addresses all these issues by using the already-existing extensibility model of DirectShow and similar development architectures to add secure transfer protocol on top of existing mechanisms. Both the filters and the media sample objects that convey content data between the filters are enhanced to support the concepts of the current invention.

A securable media sample has additional data members that define the type of data in the payload; for insecure (traditional) media samples, this would be simply the in-the-clear content data. A secured media sample can also carry secured (encrypted) content data and decryption keys. The additional data members define what type of payload a given media sample is carrying at any specific time.

A secure filter on the source side of a connection can connect to either a secure or insecure (traditional) sink filter. If it is a secure filter, that filter may also have a certificate confirming that it will not do anything that could serve to undermine the security of data flowing into it. This certificate may be embedded into the executing image of the filter, or it may be in a separate data file. Such a certificate both allows the source side of a connection to determine if the sink-side filter has been modified after the certificate was created for it, and to determine if the certificate came from a “signing authority” acceptable to the designer of the source filter. Only if a sink filter passes this certification test will the source side of the connection send it (the sink-side filter) decryption keys for secure media samples. Without these decryption keys, the sink side filter can do nothing useful with encrypted media samples it receives from the source-side filter. As a result, the source-side may continue sending encrypted media samples to the uncertified sink, since it knows that sink will not be able to use this data in any illegitimate fashion.

The certification mechanism is designed such that the confirming of the certificate is against the executing image of the filter being certified, rather than against some other image representation such as the filter's disk file. Thus, the certification takes place at the point in the filter's lifetime where the least amount of damaging alteration could be carried out by a prospective pirate. The designer of the software performing this certification validation (e.g., the source side of a filter connection) could increase the security further by doing continuous (possibly intermittent) re-certifications during the entire lifetime of the filter being certified.

The certificates are further formatted in a manner that insures that they were created by a “signing authority” acceptable to the implementer of the validating software (e.g. the connection's source-side filter) The current invention includes this as a necessary aspect of a conforming implementation.

Although the invention has been described with respect to various exemplary embodiments, it will be understood that the invention is entitled to protection within the full scope of the appended claims.

It is claimed:

1. A method of processing encrypted media content through a media processing stack, wherein the media processing stack comprises one or more ordered and successively arranged processing components, the method comprising:
receiving the media content at each successive processing component and passing the media content to a successive processing component;
optionally processing the media content at each processing component;
receiving one or more decryption keys associated with the media content at one of the processing components;
relaying the decryption keys to one or more successive processing components to a decrypting one of the processing components that is capable of decrypting the media content; and
decrypting the media content at the decrypting one of the processing components before passing the media content to the successive processing component.

2. The method of claim 1 wherein the providing is from a DVD disc.

3. The method of claim 1 wherein the providing is from a website.

4. The method of claim 1 wherein the providing, receiving, relaying, and passing comprise streaming encrypted content and keys.

5. The method of claim 1 wherein the receiving, relaying, and passing are performed at an audio processing stack.

6. The method of claim 1 wherein the receiving, relaying, and passing are performed at a video processing stack.

7. The method of claim 1 wherein the receiving, relaying, and passing are performed using common interfaces at the components.

8. The method of claim 7 wherein the common interfaces provide secure logical busses between the components.

9. The method of 1 further comprising authenticating the stack of one or more components prior to the receiving.

10. A personal computer that performs the method of claim 1.

11. A method comprising:
relaying commands through a first media processing stack of one or more components having a common protocol with one another;
receiving the decryption commands or key exchange commands at an interface; and
passing the decryption commands to the next component in the media processing stack using the common protocol.

12. The method of claim 11 wherein the common protocol is a common interface provided in the components of the media processing stack used to communicate with one another and other components and applications external to the media processing stack.

13. The method of claim 11 further comprising creating a secure logical bus through the media processing stack through implemented by the common protocol.

14. The method of claim 11 further comprising setting up an encryption session between a decrypting component and a subsequent component in the media processing stack to allow decrypted content to be re-encrypted for use by the subsequent component.

15. The method of claim 14 wherein a decryption key is passed to the decrypting component from the next component in the media processing stack.

16. A personal computer that performs the method of claim 1 1.

17. A method comprising:
establishing secure logical busses from a media source through a first media processing stack of components including a driver component;
sending data down to the driver component through the secure logical busses; and
returning data from the driver component to an interface of an application.

18. The method of claim 17 wherein the sending comprises a verb command comprised of a bit word of a set number and the returning comprises a response comprised of a bit word of the set number.

19. The method of claim 17 wherein an index value indicates the beginning of the sending of data, and an index value indicates the ending of sending data.

20. The method of claim 17 wherein the data comprises bytes and includes an index value indicating a relative location of a group comprising the data within a data stream used to communicate keys.

21. The method of claim 20 wherein the data stream is reconstructed by sorting groups by their indices.

22. The method of claim 20 wherein an identifier is included to identify a command stream associated with a content stream.

23. The method of claim 17 further comprising decrypting content at the second media processing stack independent of the first media processing stack.

24. A personal computer that performs the method of claim 17.

25. A method comprising:
parsing encrypted content from a media source based on media type;
passing the parsed encrypted content along a media processing stack of components to a decrypting component capable of decrypting the parsed encrypted content;
establishing logical busses from the media source through the stack of components to the decrypting component; and
relaying keys for decrypting encrypted content to the decrypting component.

26. The method of claim 25 wherein the parsing is performed by a navigation component coupled to an application program.

27. The method of claim 25 wherein the passing is performed through an audio processing stack.

28. The method of claim 25 wherein the passing is performed through an video processing stack.

29. The method of claim 25 wherein the parsing, passing, and relaying comprise streaming encrypted content and keys.

30. A personal computer that performs the method of claim 25.

31. An media processing stack comprising:
means for receiving and decompressing or processing encrypted content from a media source and relaying decompressed encrypted content;
means for rendering decompressed (or processed) encrypted and decrypted content and relaying decompressed rendered encrypted content;
means for receiving decompressed (or processed) rendered encrypted and decrypted content and relaying decompressed rendered encrypted content if not able to decrypt the decompressed rendered encrypted content; and
means for receiving decompressed rendered encrypted and decrypted content and decrypting decompressed rendered encrypted content, and generating audio output.

32. A computer comprising:
a processor;
a memory to store instructions executable on the processor configured to pass encrypted content and decryption information through one or more stacks of components to a decrypting component.

33. The computer of claim 32 wherein the instructions are further configured to send commands from a component in a first stack of components that affect a component in a second stack of components.

34. The computer of claim 32, wherein the command are passed on by components to other components in the first stack of components.

35. The computer of claim 32 wherein the encrypted content and decryption information are from a media source.

36. The computer of claim 32 wherein the encrypted content and decryption information are from a DVD disc.

37. The computer of claim 32 wherein the encrypted content and decryption information are from a website.

38. The computer of claim 32 further comprising creating a secure logical busses in which the encrypted content and decryption information are sent.

39. A computer-readable medium having computer-executable components comprising:
a first component to receive and optionally decompress or process encrypted content from a media source and relay decompressed or processed encrypted content a second component to render decompressed or processed encrypted and decrypted content and relay decompressed or processed rendered encrypted content if not able to decrypt the decompressed encrypted content;
a second component to receive decompressed or processed rendered encrypted and decrypted content and relay decompressed of processed rendered encrypted content if not able to decrypt the decompressed rendered encrypted content; and
a second component to receive decompressed or processing for rendered encrypted and decrypted content and decrypt decompressed or processed rendered encrypted content, and generate audio output.

40. A computer-readable medium having computer-executable components comprising:
a first component to send commands to affect an image in a component in a video stack;
a second component to relay the commands; and
a third component configured to send the commands to an interface coupled to an application that sends the commands to the component in the video processing stack.

41. A computer-readable medium having computer-executable components comprising:
a first component to receive and decompress video content from an interface and receive commands from the interface or an application program;
a second component to receiving decompressed video content and the commands from the application program or the first component and create images based on the commands;
a third component to receive the created images; and
a fourth component to generate a video output of the created images.
